(19) United States
(12) Patent Application Publication
(10) Pub. No.: US 2026/0290083 A1
(43) Pub. Date: Sep. 24, 2026

(54) SYSTEM AND METHOD FOR EVALUATING PERFORMANCE OF WORK MACHINE

(71) Applicant: KOMATSU LTD., Tokyo (JP)

(72) Inventors: Ryoji KASUYA, Tokyo (JP); Hiroshi TADENUMA, Tokyo (JP)

(21) Appl. No.: 19/478,295

(22) PCT Filed: May 23, 2024
(86) PCT No.: PCT/JP2024/019103

§ 371 Date: Oct. 24, 2025

(30) Foreign Application Priority Data
Jul. 31, 2023 (JP) 2023-124672

(51) Int. Cl. G07C 5/02; F02D 41/02

(52) U.S. Cl. CPC G07C 5/02; F02D 41/0215; F02D 2200/50

(57) ABSTRACT

A system evaluated performance of a work machine including an engine. The system includes a target torque acquisition, an actual torque acquisition unit, a torque correction unit, and a torque ratio calculation unit. The target torque acquisition unit acquires a target output torque of the engine. The actual torque acquisition unit acquires an actual output torque of the engine. The torque correction unit acquires a first change amount of a first correction parameter in order to change a target output torque of the engine, and corrects the actual output torque based on the first change amount. The torque ratio calculation unit calculates a ratio between the target output torque and the corrected actual output torque as a torque ratio in order to evaluate the performance.

### CROSS-REFERENCE TO RELATED APPLICATIONS

This application is a U.S. National stage application of International Application No. PCT/JP2024/019103, filed on May 23, 2024. This U.S. National stage application claims priority under 35 U.S.C. § 119(a) to Japanese Patent Application No. 2023-124672, filed in Japan on Jul. 31, 2023. The entire contents of Japanese Patent Application No. 2023-124672 is hereby incorporated herein by reference.

### BACKGROUND

### Technical Field

The present disclosure relates to a system and a method for evaluating the performance of a work machine.

### Background Art

A method for evaluating the performance of an engine based on the torque ratio of the engine has been known. The torque ratio of the engine is a ratio between a target output torque and an actual output torque of the engine. The torque ratio indicates the degree of deviation of the actual output torque from the target output torque of the engine. Therefore, the performance of the engine can be evaluated using the torque ratio.

In order to properly evaluate the performance of the engine, it is required to accurately calculate the torque ratio. Therefore, the torque ratio is calculated based on data acquired when a predetermined condition is satisfied. For example, in an abnormality determination device for a vehicle of Japanese Laid-Open Patent Publication No. 2013-184512 A, an actual output torque of an engine is calculated based on data acquired with a pressure of fuel of the engine kept constant.

### SUMMARY

In the above-described abnormality determination device for a vehicle, the actual output torque of the engine is calculated from the data acquired in the state where the vehicle is stable. Thus, the torque ratio can be accurately calculated. With the predetermined condition being stricter, the torque ratio can be more accurately calculated.

However, in a work machine used at a work site such as a mine, the torque ratio can be calculated in the stable state under limited number of situations, compared with the vehicle described above. Therefore, if the accuracy of the calculation of the torque ratio is improved by making the predetermined condition stricter, only a small amount of data can be used for the performance evaluation. Therefore, improvement in the accuracy of performance evaluation is not an easy task. An object of the present disclosure is to accurately calculate a torque ratio in a work machine.

A system according to a first aspect of the present disclosure is a system for evaluating performance of a work machine. The work machine includes an engine. A system according to a first aspect includes a target torque acquisition unit, an actual torque acquisition unit, a torque correction unit, and a torque ratio calculation unit. The target torque acquisition unit acquires a target output torque of the engine. The actual torque acquisition unit acquires an actual output torque of the engine. The torque correction unit acquires a first change amount of a first correction parameter for changing the target output torque of the engine. The torque correction unit corrects the actual output torque based on the first change amount. The torque ratio calculation unit calculates a ratio between the target output torque and the corrected actual output torque as a torque ratio for evaluating the performance.

In the system of the present aspect, the actual output torque is corrected based on the first change amount. The first change amount indicates the change amount of the first correction parameter for changing the target output torque of the engine. Therefore, the actual output torque is corrected in consideration of a change in the operating state of the engine. Accordingly, the torque ratio can be calculated with high accuracy in the work machine.

A system according to a second aspect of the present disclosure is a system for evaluating performance of a work machine. The work machine includes an engine and a torque converter connected to the engine. The system according to the second aspect includes a target torque acquisition unit, an actual torque acquisition unit, a torque correction unit, and a torque ratio calculation unit. The target torque acquisition unit acquires a target output torque of the engine. The actual torque acquisition unit acquires an input torque to the torque converter as an actual output torque of the engine. The torque correction unit acquires a change amount of a predetermined correction parameter indicating an operating state of the torque converter. The torque correction unit corrects the actual output torque based on the change amount. The torque ratio calculation unit calculates a ratio between the target output torque and the corrected actual output torque as a torque ratio for evaluating the performance.

In the system of the present aspect, the actual output torque is corrected based on the change amount of the predetermined correction parameter. The predetermined correction parameter indicates the operating state of the torque converter. Therefore, the actual output torque is corrected in consideration of a change in the operating state of the torque converter. Accordingly, the torque ratio can be calculated with high accuracy in the work machine.

A method according to a third aspect of the present disclosure is a method for evaluating performance of a work machine. The work machine includes an engine. The method according to the third aspect includes acquiring a target output torque of the engine, acquiring an actual output torque of the engine, acquiring a first change amount of a first correction parameter for changing the target output torque of the engine and correcting the actual output torque based on the first change amount, and calculating a ratio between the target output torque and the corrected actual output torque as a torque ratio for evaluating the performance.

In the method of the present aspect, the actual output torque is corrected based on the first change amount. The first change amount indicates the change amount of the first correction parameter for changing the target output torque of the engine. Therefore, the actual output torque is corrected in consideration of a change in the operating state of the engine. Accordingly, the torque ratio can be calculated with high accuracy in the work machine.

A method according to a fourth aspect of the present disclosure is a method for evaluating performance of a work machine. The work machine includes an engine and a torque converter connected to the engine. The method according to the fourth aspect includes acquiring a target output torque of the engine, acquiring an input torque to the torque converter as an actual output torque of the engine, acquiring a change amount of a predetermined correction parameter indicating an operating state of the torque converter and correcting the actual output torque based on the change amount, and calculating a ratio between the target output torque and the corrected actual output torque as a torque ratio for evaluating the performance.

In the system of the present aspect, the actual output torque is corrected based on the change amount of the predetermined correction parameter. The predetermined correction parameter indicates the operating state of the torque converter. Therefore, the actual output torque is corrected in consideration of a change in the operating state of the torque converter. Accordingly, the torque ratio can be calculated with high accuracy in the work machine.

According to the present disclosure, the torque ratio can be calculated with high accuracy in the work machine.

### BRIEF DESCRIPTION OF DRAWINGS

Referring now to the attached drawings which form a part of this original disclosure, an illustrative embodiment is shown.

FIG. 1 is a perspective view of a work machine according to an embodiment.

FIG. 2 is a block diagram illustrating a configuration of the work machine and a system for evaluating the performance of the work machine.

FIG. 3 is a table illustrating a configuration of machine data.

FIG. 4 is a block diagram illustrating a configuration of a server.

FIG. 5 is a flowchart illustrating processing of generating determination data for evaluating the performance.

FIG. 6 is a diagram illustrating an example of primary torque coefficient data.

### DETAILED DESCRIPTION OF EMBODIMENT(S)

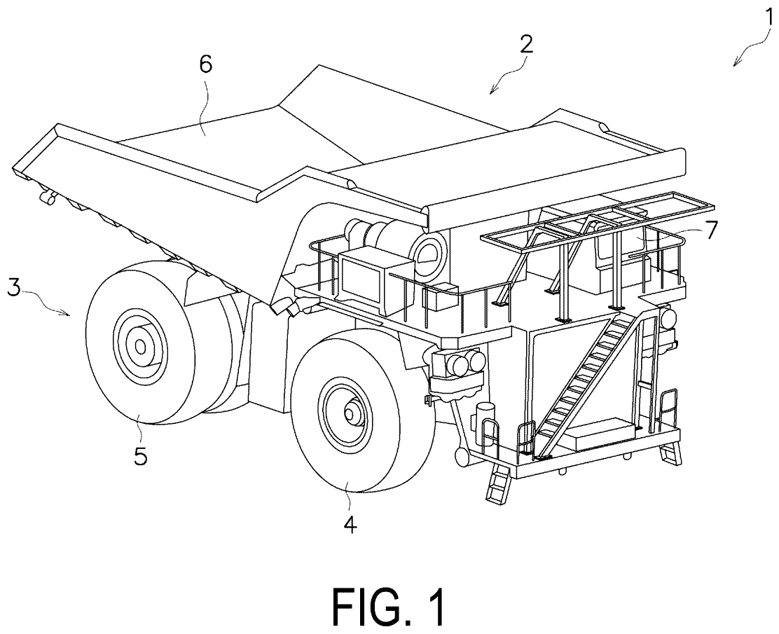

Hereinafter, an embodiment of the present disclosure will be described with reference to the accompanying drawings. FIG. 1 is a perspective view of a work machine 1 according to the embodiment. The work machine 1 according to the present embodiment is a dump truck. As illustrated in FIG. 1, the work machine 1 includes a vehicle body 2 and a traveling device 3. The vehicle body 2 includes a loading platform 6 and a cab 7. The traveling device 3 is attached to the vehicle body 2. The traveling device 3 includes traveling wheels 4 and 5.

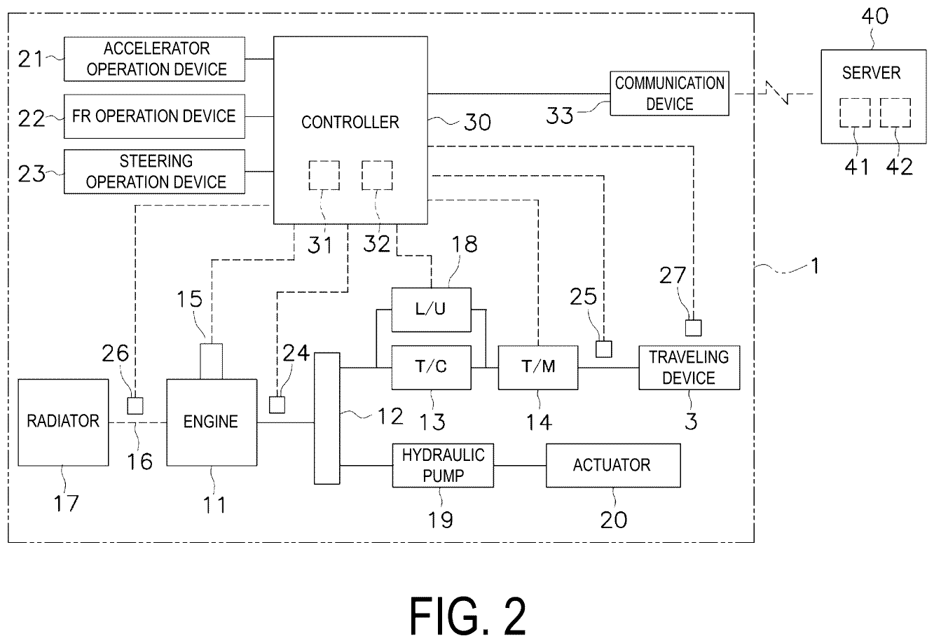

FIG. 2 is a block diagram illustrating a configuration of the work machine 1 and a system for evaluating performance of the work machine 1. As illustrated in FIG. 2, the work machine 1 includes an engine 11, a power take-off (PTO) 12, a torque converter 13, and a transmission 14. The engine 11 is, for example, a diesel engine. A fuel injection device 15 is connected to the engine 11. The fuel injection device 15 injects the fuel into the engine 11. A radiator 17 is connected to the engine 11 via a cooling pipe 16. The radiator 17 cools a coolant for the engine 11.

The torque converter 13 is connected to the engine 11 via the PTO 12. The torque converter 13 transmits the driving force from the engine 11 to the transmission 14. A lock-up clutch 18 is connected to the torque converter 13. The lock-up clutch 18 is switched between an engaged state and a disengaged state. The lock-up clutch 18 in the engaged state directly connects the input side and the output side of the torque converter 13.

The transmission 14 is connected to the torque converter 13. The transmission 14 transmits the driving force from the torque converter 13 to the traveling device 3. Thus, the traveling device 3 is driven and the work machine 1 travels. The transmission 14 includes a plurality of shift gears, a forward gear, a reverse gear, and a clutch. The clutch switches the engagement of each gear. The transmission 14 can be switched among a plurality of speed stages through the switching of engagement of the plurality of shift gears. The transmission 14 can be switched among three or more speed stages for example.

The work machine 1 includes a hydraulic pump 19 and an actuator 20. The hydraulic pump 19 is connected to the engine 11 via the PTO 12. The hydraulic pump 19 discharges hydraulic oil upon being driven by the engine 11. The actuator 20 is driven by the hydraulic oil from the hydraulic pump 19. The actuator 20 includes, for example, a steering actuator for steering the traveling wheels 4. Note that, although only one hydraulic pump 19 is illustrated in FIG. 2, the work machine 1 may include a plurality of hydraulic pumps. Although only one actuator 20 is illustrated in FIG. 2, the work machine 1 may include a plurality of actuators.

The work machine 1 includes an accelerator operation device 21, an FR operation device 22, and a steering operation device 23. The accelerator operation device 21 can be operated by an operator in order to adjust the vehicle speed of the work machine 1. The accelerator operation device 21 includes, for example, an accelerator pedal. Alternatively, the accelerator operation device 21 may include a lever or a switch. The accelerator operation device 21 outputs an accelerator operation signal indicating an operation on the accelerator operation device 21.

The FR operation device 22 is operable by an operator to switch between forward movement and rearward movement of the work machine 1. The FR operation device 22 includes an FR lever for example. Alternatively, the FR operation device 22 may include a switch. The FR operation device 22 outputs an FR operation signal indicating an operation on the FR operation device 22.

The steering operation device 23 can be operated by an operator in order to steer the work machine 1. The steering operation device 23 includes, for example, a steering wheel. Alternatively, the steering operation device 23 may include a lever or a switch. The steering operation device 23 outputs a steering operation signal indicating an operation on the steering operation device 23.

The work machine 1 includes an engine rotation speed sensor 24 and an output rotation speed sensor 25. The engine rotation speed sensor 24 detects the engine rotation speed. The output rotation speed sensor 25 detects the output rotation speed of the transmission 14.

The work machine 1 includes a cooling temperature sensor 26. The cooling temperature sensor 26 detects the temperature of the coolant for the engine 11. The work machine 1 includes a steering angle sensor 27. The steering angle sensor 27 detects a steering angle of the traveling wheels 4.

The work machine 1 includes a controller 30. The controller 30 controls the work machine 1. The controller 30 includes a storage device 31 and a processor 32. The storage device 31 includes a memory such as a RAM and a ROM for example. The storage device 31 may include a storage such as an HDD or an SSD. The storage device 31 stores a program and data for controlling the work machine 1. The processor 32 is, for example, a CPU. The processor 32 executes processing of controlling the work machine 1, in accordance with the program and data.

The controller 30 acquires the rotation speed of the engine from the engine rotation speed sensor 24. The controller 30 acquires the output rotation speed of the transmission 14 from the output rotation speed sensor 25. The controller 30 acquires the temperature of the coolant for the engine 11 from the cooling temperature sensor 26. The controller 30 acquires the steering angle of the traveling wheels 4 from the steering angle sensor 27.

The controller 30 receives the accelerator operation signal from the accelerator operation device 21. The controller 30 determines the target rotation speed of the engine 11 in accordance with the accelerator operation signal. The controller 30 controls the fuel injection amount from the fuel injection device 15 in accordance with the accelerator operation signal. The fuel injection amount from the fuel injection device 15 may be directly controlled in accordance with the operation on the accelerator operation device 21, without depending on the controller 30.

The controller 30 receives the FR operation signal from the FR operation device 22. The controller 30 switches the forward and the reverse of the transmission 14 according to the FR operation signal. The forward and reverse of the transmission 14 may be directly switched in accordance with the operation on the FR operation device 22, without depending on the controller 30.

The controller 30 switches the speed stage of the transmission 14 according to the vehicle speed or the engine rotation speed. The controller 30 calculates the vehicle speed from, for example, the output rotation speed of the transmission 14. The controller 30 switches the lock-up clutch 18 between engaged and disengaged, according to the vehicle speed or the engine rotation speed.

The controller 30 receives the steering operation signal from the steering operation device 23. The controller 30 controls the actuator 20 so as to change the steering angle of the traveling wheels 4 in accordance with the steering operation signal. The actuator 20 may be directly controlled in accordance with the operation on the steering operation device 23, without depending on the controller 30.

The work machine 1 includes the communication device 33. The communication device 33 is communicably connected to the controller 30. The communication device 33 communicates with a server 40 outside the work machine 1 by wireless communication. The server 40 remotely monitors the state of the work machine 1 by machine data indicating the state of the work machine 1.

The server 40 includes a storage device 41 and a processor 42. The storage device 41 includes a memory such as a RAM and a ROM for example. The storage device 41 may include a storage such as an HDD or an SSD. The storage device 41 stores a program and data for monitoring the state of the work machine 1. The processor 42 is, for example, a CPU. The processor 42 executes processing of monitoring the state of the work machine 1, in accordance with the program and data.

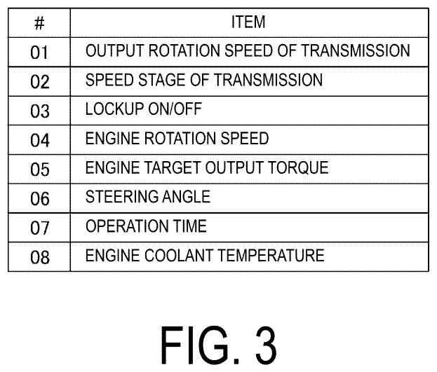

The controller 30 of the work machine 1 transmits the machine data to the server 40 via the communication device 33. FIG. 3 is a table illustrating a configuration of the machine data. As illustrated in FIG. 3, the machine data includes the output rotation speed of the transmission 14, the speed stage of the transmission 14, the lock-up on/off, the engine rotation speed, the target output torque of the engine 11, the steering angle, the operation time, and the temperature of the coolant for the engine 11.

The lock-up on means that the lock-up clutch 18 is in the engaged state. The lock-up off means that the lock-up clutch 18 is in the disengaged state. The target output torque of the engine 11 is calculated based on the rotation speed of the engine 11 and the fuel injection amount. The operation time is, for example, an integrated value of time during which the engine 11 is driven. The controller 30 counts and records the operation time.

The work machine 1 samples the above-described data at a predetermined sampling interval and stores the data as the machine data in the storage device 31. The work machine 1 transmits the accumulated machine data to the server 40 at a predetermined transmission timing. For example, upon entering a communicable area of a wireless LAN or the like, the work machine 1 transmits the accumulated machine data to the server 40. The server 40 generates determination data for evaluating the performance of the work machine 1 based on the received machine data. Hereinafter, processing executed by the server 40 for generating the determination data for evaluating performance will be described.

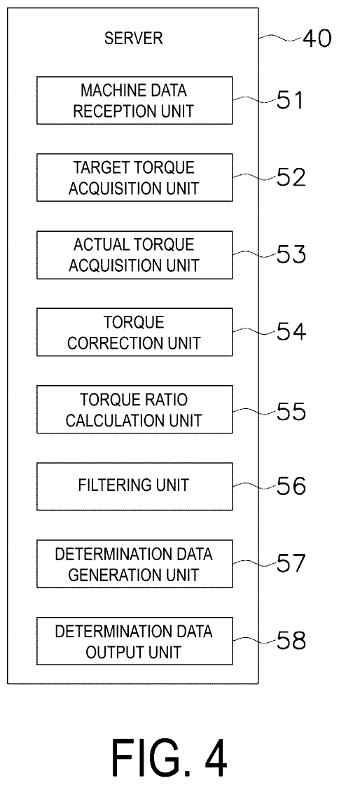

FIG. 4 is a block diagram illustrating a configuration of the server 40. As illustrated in FIG. 4, the server 40 includes a machine data reception unit 51, a target torque acquisition unit 52, an actual torque acquisition unit 53, a torque correction unit 54, a torque ratio calculation unit 55, a filtering unit 56, a determination data generation unit 57, and a determination data output unit 58. The machine data reception unit 51, the target torque acquisition unit 52, the actual torque acquisition unit 53, the torque correction unit 54, the torque ratio calculation unit 55, the filtering unit 56, the determination data generation unit 57, and the determination data output unit 58 are realized by the processor 42 of the server 40.

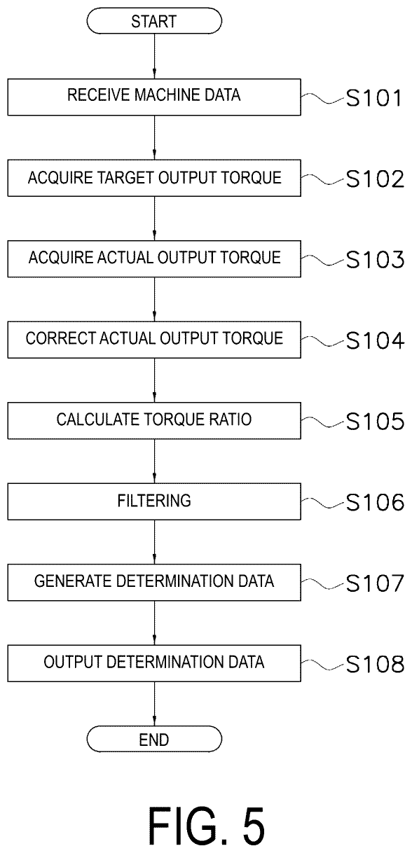

FIG. 5 is a flowchart illustrating the processing of generating the determination data for evaluating the performance. As illustrated in FIG. 5, in step S101, the machine data reception unit 51 receives machine data. The machine data reception unit 51 receives the above-described machine data from the controller 30 of the work machine 1. In step S102, the target torque acquisition unit 52 acquires the target output torque of the engine 11. The target torque acquisition unit 52 acquires the target output torque of the engine 11 from the machine data received from the controller 30 of the work machine 1.

In step S103, the actual torque acquisition unit 53 acquires the actual output torque of the engine 11. The actual output torque of the engine 11 means a torque supplied to the torque converter 13 among all the actual output torque of the engine 11. A part of the actual output torque of the engine 11 (hereinafter, referred to as PTO transmission torque) is supplied to the hydraulic pump 19 via the PTO 12. The actual torque acquisition unit 53 acquires an input torque to the torque converter 13 as an actual output torque. Specifically, the actual torque acquisition unit 53 calculates a primary torque coefficient of the torque converter 13 based on the speed ratio of the torque converter 13. The actual torque acquisition unit 53 calculates the input torque to the torque converter 13 based on the primary torque coefficient and the input rotation speed of the torque converter 13.

The primary torque coefficient indicates the characteristics of the torque converter 13. The relationship between the primary torque coefficient of the torque converter 13 and the input torque to the torque converter 13 is expressed by the following Formula (1), where Tp is a primary torque coefficient, Ttci is an input torque to the torque converter 13, and Ti is the input rotation speed of the torque converter 13.

$${T}_{p} = \frac{{T}_{tci}}{{T}_{i}^{2}} \qquad ( 1 )$$

From the above Formula (1), the input torque Ttci to the torque converter 13 is expressed by the following Formula (2): Here, Ne is the engine rotation speed, and corresponds to the input rotation speed Ti of the torque converter 13. Using Formula (2), the actual torque acquisition unit 53 calculates the input torque Ttci to the torque converter 13 based on the primary torque coefficient Tp and the engine rotation speed Ne.

$${T}_{tci} = {T}_{p} \times {N}_{e}^{2} \qquad ( 2 )$$

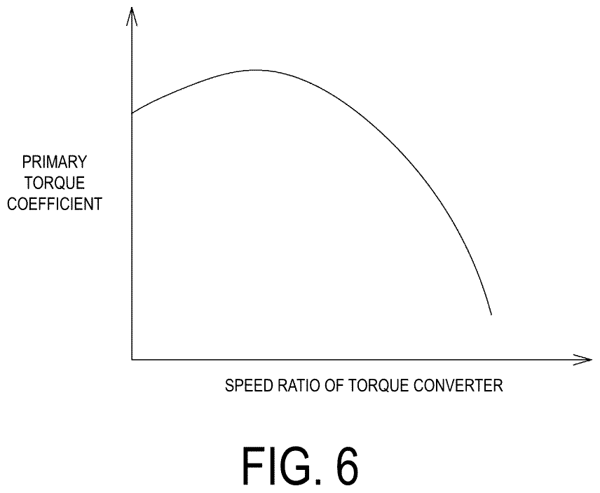

The actual torque acquisition unit 53 refers to the primary torque coefficient data illustrated in FIG. 6, and calculates the primary torque coefficient Tp based on the speed ratio of the torque converter 13. The primary torque coefficient data indicates a relationship between the primary torque coefficient of the torque converter 13 and the speed ratio of the torque converter 13. The primary torque coefficient data is obtained in advance by simulation, bench test, or the like, and is stored in the storage device 41.

The speed ratio of the torque converter 13 is a ratio between the input rotation speed and the output rotation speed of the torque converter 13. The actual torque acquisition unit 53 acquires the input rotation speed and the output rotation speed of the torque converter 13 from the above-described machine data, and calculates the speed ratio. Specifically, the actual torque acquisition unit 53 acquires the engine rotation speed as the input rotation speed of the torque converter 13. The actual torque acquisition unit 53 calculates the output rotation speed of the torque converter 13 based on the output rotation speed of the transmission 14 and the speed stage of the transmission 14. Alternatively, the actual torque acquisition unit 53 may directly acquire the output rotation speed of the torque converter 13 as the machine data.

In step S104, the torque correction unit 54 corrects the actual output torque of the engine 11 acquired in step S103. The torque correction unit 54 corrects the actual output torque using the following Formula (3), where Tcicorr is the corrected actual output torque, and Te is a first correction parameter for changing the target output torque of the engine 11. In the present embodiment, Te is the target output torque of the engine 11, and Ntm is a second correction parameter indicating the operating state of the torque converter 13. In the present embodiment, Ntm is the output rotation speed of the torque converter 13.

$${T}_{Cicorr} = {T}_{p} {N}_{e}^{2} + ( α \times {\dot{T}}_{e} ) + ( β \times {N}_{tm}^{′} ) \qquad ( 3 )$$

The torque correction unit 54 corrects the actual output torque Tp based on the first change amount and the second change amount. The first change amount indicates a change amount of the first correction parameter over time. The second change amount indicates a change amount of the second correction parameter over time. As can be seen in Formula (3), in the present embodiment, the first change amount is a time derivative value of the target output torque Te. The second change amount is a time derivative value of the output rotation speed Ntm of the torque converter 13.

The torque correction unit 54 acquires the target output torque Te of the engine 11 and the output rotation speed Ntm of the torque converter 13 from the machine data. Here, α and β are predetermined coefficients obtained in advance by simulation, bench test, or the like, and stored in the storage device 41. Alternatively, α and β may be estimated from the actual operation record of the work machine 1.

In step S105, the torque ratio calculation unit 55 calculates the torque ratio. The torque ratio calculation unit 55 calculates the torque ratio using the following Formula (4): That is, the torque ratio calculation unit 55 calculates the ratio between the target output torque Te and the corrected actual output torque Tcicorr as the torque ratio Rt for evaluating the performance of the engine 11 or the torque converter 13. Here, γ is a predetermined coefficient determined in consideration of the PTO transmission torque, obtained in advance by simulation, bench test, or the like, and stored in the storage device 41. Alternatively, γ may be estimated from the actual operation record of the work machine 1.

$${R}_{t} = \frac{{T}_{Cicorr} + γ}{{T}_{e}} \qquad ( 4 )$$

In step S106, the filtering unit 56 performs filtering for the torque ratio calculated in step S105. The filtering unit 56 selects the torque ratio acquired when a predetermined condition is satisfied. The predetermined condition includes the following first to ninth conditions.

The first condition is that the speed stage of the transmission 14 is a predetermined speed stage. For example, the filtering unit 56 determines that the first condition is satisfied when the speed stage of the transmission 14 is the first forward speed, the second forward speed, or the first reverse speed. The second condition is that the speed stage of the transmission 14 remains unchanged. The third condition is that lock-up is off. The fourth condition is that the engine rotation speed is at or higher than a predetermined lower limit value. The fifth condition is that the target output torque of the engine 11 is within a predetermined range. The sixth condition is that the speed ratio of the torque converter 13 is within a predetermined range. The seventh condition is that the steering angle is within a predetermined range. The eighth condition is that a change in the steering angle is within a predetermined range. The ninth condition is that the temperature of the coolant for the engine 11 is at or higher than a predetermined lower limit value.

The filtering unit 56 determines whether the first to the ninth conditions are satisfied based on the machine data described above. The filtering unit 56 selects the torque ratio that satisfies all of the first to the ninth conditions. The filtering unit 56 excludes the torque ratio that does not satisfy at least one of the first to the ninth conditions.

In step S107, the determination data generation unit 57 generates the determination data. The determination data generation unit 57 records the torque ratios selected in step S106 in time series, thereby generating the determination data for evaluating the performance. For example, the determination data generation unit 57 calculates an average value of the torque ratio for each predetermined operation time, and generates time-series data of the average value of the torque ratio as the determination data.

In step S108, the determination data output unit 58 outputs the determination data. For example, the determination data output unit 58 transmits the determination data to a computer of a user of the work machine 1. Alternatively, the determination data output unit 58 may cause a display to display the determination data, using an application for managing the work machine 1.

The server 40 may evaluate the performance of the engine 11 or the torque converter 13 based on the determination data. The determination data output unit 58 may transmit the evaluation result of the performance of the engine 11 or the torque converter 13 determined based on the determination data to the computer of the user of the work machine 1. For example, the server 40 may determine that the performance of the engine 11 or the torque converter 13 has been suddenly compromised, in response to a sharp decrease in the torque ratio in the determination data. The server 40 may determine that the performance of the engine 11 or the torque converter 13 has been compromised due to aging deterioration, when the torque ratio in the determination data is at or lower than a predetermined threshold.

In the system for evaluating the performance of the work machine 1 according to the present embodiment described above, the actual output torque of the engine 11 is correct based on the time derivative value of the target output torque of the engine 11 and the time derivative value of the output rotation speed of the torque converter 13. Therefore, the actual output torque is corrected in consideration of a change in the load on the work machine 1 or change in the operating state of the engine 11 according to the operation on the accelerator operation device 21 and a change in the operating state of the torque converter 13. Accordingly, the torque ratio can be calculated with high accuracy in the work machine 1.

Although one embodiment of the present invention has been described above, the present invention is not limited to the above-described embodiment, and various modifications can be made without departing from the gist of the invention.

The work machine 1 is not limited to a dump truck and may be another machine such as a bulldozer, an excavator, a wheel loader or a grader. The dump truck is not limited to a rigid dump truck, and may be an articulated dump truck. The traveling device 3 is not limited to the traveling wheels 4, and may include a crawler belt. The work machine 1 may include a plurality of controllers. The processing for controlling the work machine 1 by the controller 30 described above may be distributed to and executed by the plurality of controllers.

The work machine 1 may be remotely operable. In this case, the accelerator operation device 21, the FR operation device 22, and the steering operation device 23 may be arranged outside the work machine 1. The work machine 1 may be capable of autonomous traveling. In this case, the accelerator operation signal, the FR operation signal, and the steering operation signal may be automatically generated by the controller 30.

The processing for generating the determination data described above may be executed by the controller 30 of the work machine 1. Alternatively, the processing for generating the determination data described above may distributed to and executed by the controller 30 of the work machine 1 and the server 40. The evaluation of the performance of the engine 11 or the torque converter 13 may be performed by the controller 30 of the work machine 1. The controller 30 may display the evaluation of the performance of the engine 11 or the torque converter 13 on a display of the work machine 1.

The method for generating the determination data is not limited to that of the above embodiment and may be modified. For example, the first correction parameter is not limited to the target output torque of the engine 11. The first correction parameter may be a fuel injection amount, an instantaneous fuel consumption amount, an operation amount on the accelerator operation device 21, or a throttle opening degree. The second correction parameter is not limited to the output rotation speed of the torque converter 13. For example, the second correction parameter may be the input rotation speed of the torque converter 13. The first change amount and the second change amount are not limited to the derivative values, and may be changed. For example, the first change amount and the second change amount may be change amounts per predetermined unit time.

The input torque to the torque converter 13 is not limited to the primary torque coefficient, and may be estimated by another method. For example, the input torque to the torque converter 13 may be estimated by means such as a mathematical expression, a table, or a map based on the input rotation speed and the output rotation speed of the torque converter 13.

The predetermined conditions for filtering the torque ratio are not limited to those of the above embodiment and may be modified. Some of the first to the ninth conditions described above may be omitted or changed. For example, the predetermined condition may include a condition related to filtering based on the hydraulic oil temperature. The machine data is not limited to that of the above embodiment and may be modified. For example, when the work machine 1 includes a sensor that detects the output rotation speed of the torque converter 13, the machine data may include the detected output rotation speed of the torque converter 13.

According to the present disclosure, the torque ratio can be calculated with high accuracy in the work machine.

1. A system for evaluating performance of a work machine including an engine, the system comprising:
a target torque acquisition unit configured to acquire a target output torque of the engine;
an actual torque acquisition unit configured to acquire an actual output torque of the engine;
a torque correction unit configured to
acquire a first change amount of a first correction parameter in order to change a target output torque of the engine and
correct the actual output torque based on the first change amount;
a torque ratio calculation unit configured to calculate a ratio between the target output torque and the corrected actual output torque as a torque ratio in order to evaluate the performance.

2. The system according to claim 1, wherein
the first correction parameter is the target output torque.

3. The system according to claim 2, wherein
the first change amount is a time derivative value of the target output torque.

4. The system according to claim 1, wherein
the work machine includes a torque converter connected to the engine, and
the actual torque acquisition unit is configured to acquire, as the actual output torque, an input torque to the torque converter calculated based on at least one of an input rotation speed and an output rotation speed of the torque converter.

5. The system according to claim 4, wherein
the actual torque acquisition unit is configured to
acquire a speed ratio between the input rotation speed and the output rotation speed of the torque converter,
calculate a primary torque coefficient of the torque converter based on the speed ratio, and
calculate the input torque to the torque converter based on the primary torque coefficient.

6. The system according to claim 4, wherein
the torque correction unit is configured to
acquire a second change amount of a second correction parameter indicating an operating state of the torque converter, and
correct the actual output torque based on the second change amount.

7. The system according to claim 6, wherein
the second correction parameter is the input rotation speed or the output rotation speed of the torque converter.

8. The system according to claim 7, wherein
the second change amount is a time derivative value of the input rotation speed or the output rotation speed of the torque converter.

9. The system according to claim 1 further comprising:
a filtering unit configured to select the torque ratio acquired when a predetermined condition is satisfied,
the predetermined condition including the target output torque of the engine being within a predetermined range.

10. The system according to claim 4 further comprising:
a filtering unit configured to select the torque ratio acquired when a predetermined condition is satisfied,
the predetermined condition including a speed ratio being within a predetermined range, with the speed ratio being a ratio between the input rotation speed and the output rotation speed of the torque converter.

11. The system according to claim 1 further comprising:
a determination data generation unit configured to generate data in order to evaluate the performance by recording the torque ratio in time series.

12. A system for evaluating performance of a work machine including an engine and a torque converter connected to the engine, the system comprising:
a target torque acquisition unit configured to acquire a target output torque of the engine;
an actual torque acquisition unit configured to acquire an input torque to the torque converter as an actual output torque of the engine;
a torque correction unit configured to
acquire a change amount of a predetermined correction parameter indicating an operating state of the torque converter and
correct the actual output torque based on the change amount; and
a torque ratio calculation unit configured to calculate a ratio between the target output torque and the corrected actual output torque as a torque ratio in order to evaluate the performance.

13. The system according to claim 12, wherein
the actual torque acquisition unit is configured to calculate an input torque to the torque converter calculated based on at least one of an input rotation speed and an output rotation speed of the torque converter.

14. The system according to claim 13, wherein
the actual torque acquisition unit is configured to
acquire a speed ratio that is a ratio between the input rotation speed and the output rotation speed of the torque converter,
calculate a primary torque coefficient of the torque converter based on the speed ratio, and
calculate the input torque to the torque converter based on the primary torque coefficient.

15. The system according to claim 12, wherein
the predetermined correction parameter is an input rotation speed or an output rotation speed of the torque converter.

16. The system according to claim 15, wherein
the change amount is a time derivative value of the input rotation speed or the output rotation speed of the torque converter.

17. The system according to claim 12 further comprising:
a determination data generation unit configured to generate data in order to evaluate the performance by recording the torque ratio in time series.

18. A method for evaluating performance of a work machine including an engine, the method comprising:
acquiring a target output torque of the engine;
acquiring an actual output torque of the engine;
acquiring a first change amount of a first correction parameter in order to change a target output torque of the engine and correcting the actual output torque based on the first change amount; and
calculating a ratio between the target output torque and the corrected actual output torque as a torque ratio in order to evaluate the performance.

19. A method for evaluating performance of a work machine including an engine and a torque converter connected to the engine, the method comprising:
acquiring a target output torque of the engine;
acquiring an input torque to the torque converter as an actual output torque of the engine;
acquiring a change amount of a predetermined correction parameter indicating an operating state of the torque converter and correcting the actual output torque based on the change amount; and
calculating a ratio between the target output torque and the corrected actual output torque as a torque ratio in order to evaluate the performance.
